(19) United States
(12) Patent Application Publication
(10) Pub. No.: US 2002/0144637 A1
(43) Pub. Date: Oct. 10, 2002

(54) Material decelerator for an air delivery system

(76) Inventors: Ignatz Wendling, Zweibruecken (DE); Lyle Eugene Stephens, Hampton, IL (US); Larry Patrick Ferguson, Bettendorf, IA (US); Luc Janelle, Colona, IL (US); Brian J. Maas, Bettendorf, IA (US); Jay Harold Olson, Moline, IL (US); David Walter Gregor, Davenport, IA (US)

Correspondence Address: Duane A. Coordes, Patent Department, DEERE & COMPANY, One John Deere Place, Moline, IL, 61265-8098, US

(21) Appl. No.: 09/814,595

(22) Filed: Mar. 22, 2001

(51) Int. Cl. A01C 5/00

(52) U.S. Cl. 111/163

(57) ABSTRACT

The entire right, title and interest in and to this application and all subject matter disclosed and/or claimed therein, including any and all divisions, continuations, reissues, etc., thereof are, effective as of the date of execution of this application, assigned, transferred, sold and set over by the applicant(s) named herein to Deere & Company, a Delaware corporation having offices at Moline, Ill. 61265, U.S.A., together with all rights to file, and to claim priorities in connection with, corresponding patent applications in any and all foreign countries in the name of Deere & Company or otherwise.

### FIELD OF THE INVENTION

The present invention relates generally to agricultural planting devices and, more specifically, to a device for decelerating seeds or other materials transported in an air stream to a furrow.

### BACKGROUND OF THE INVENTION

Transporting seeds and fertilizers and similar materials to the opener on a planter, seeders or other similar types of agricultural devices is commonly facilitated by directing air through a conduit and entraining the materials in the air stream for delivery to a furrow formed by the opener. The materials are transported at high speeds in the relatively high volume air stream and often bounce or are blown out of the furrow, especially if the air is exhausted out of the furrow. Seeds which bounce but remain in the furrow will not be properly spaced, and those which bounce out of the furrow or are not placed near the bottom of the furrow do not grow or germinate properly and fail to develop into healthy plants. Fertilizer or seed treatment that is misplaced is ineffective to nourish plants or protect the seeds.

Seed brake devices for slowing down seeds prior to placement in the furrow typically involve impacting the seed against a mechanical device, but the impact often shatters or otherwise damages the seed and subjects the device to substantial wear. Ridges or steps anywhere in the seed path can damage seeds and result in wear of the device. Any narrowing of the path in the air system can result in flow restrictions and wear areas, and plugging by large seeds or trash is not uncommon. Further, if air is not exhausted from the stream the seeds can actually be accelerated again after initially being slowed, and such acceleration results in the seeds being blown or bouncing out of the furrow. Devices which reduce air velocity near the conduit exit often do not slow the seed sufficiently to avoid seed bounce in the furrow. Exhausting air presents additional difficulties relating to potential loss of some of the conveyed material through the air exhaust and the blowing of dust around the machine. If screens or other filter devices are used, the filters are prone to plugging and require cleaning or replacement. Providing a compact, inexpensive and reliable seed brake that does not damage seeds has been a continuing source of problems.

### SUMMARY OF THE INVENTION

It is therefore an object of the invention to provide an improved material decelerating device for use in an agricultural air distribution system. It is another object to provide such a system which overcomes most or all of the aforementioned problems.

It is a further object of the invention to provide an improved material decelerating device particularly useful in an air distribution system for an agricultural implement such as a planter or air seeder which eliminates or substantially reduces seed damage and material bounce. It is another object to provide such a device which reduces speed of the material just prior to the material entering a furrow. It is another object of the invention to provide such a device which obviates restrictions and screens or filters for the air distribution lines, thereby eliminating sources of wear and plugging.

It is yet another object to provide a material decelerating device for an air seeding implement or the like which exhausts a substantial amount of air and reduces air velocity upstream of the material exit to prevent acceleration after the material has slowed. It is another object to provide such a device which reduces or eliminates the incidences of material bouncing in the furrow or blowing or bouncing out of the furrow. It is still a further object of the invention to provide such a device which is compact, inexpensive and easy to connect.

It is another object of the invention to provide an improved material decelerating device for material transport system of an implement which places seed or other materials in a furrow, wherein the material is transported by a relatively high volume of air, and wherein the material is slowed and a substantial portion of the air is exhausted upstream of the furrow to reduce or eliminate material re-acceleration and improve material placement in the furrow. It is a further object to provide such a device which is relatively compact and inexpensive and easy to mount.

It is still another object to provide an improved decelerating device for an air system that conveys seed or other similar material on an agricultural implement, wherein a substantial portion of the air is exhausted from the system upstream of the material exit area. It is another object to provide such a device wherein the exhausted air can be recirculated, returned to a material hopper or container on the implement, or directed towards the ground.

A material decelerating device is described for gently slowing seeds or other materials in the air delivery system of an agricultural implement and for exhausting air from the system. The device as shown is generally in the form of a cyclone type separator connected to the delivery conduit directly above the seed boot on furrow opening device and includes a hollow body with an inlet opening generally tangentially into a cylindrical portion. A material outlet opens downwardly in the axial direction from a funnel-shaped portion tapering radially inwardly in the downstream direction. An opening near the top of the cylindrical portion exhausts air upstream of the material outlet to reduce the amount of air exiting the material outlet. The opening includes a cylindrical extension generally concentric with the portion and opening downwardly at a central location below the inlet so that the air escapes without loss of the material being transported.

The device slows the material by centrifugal force without cracking or otherwise damaging seeds. Exhausting a substantial portion of the air near the furrow opening device prevents re-acceleration and seed bounce in the furrow. The device is compact and can be conveniently and easily attached directly above the furrow opening device. In one embodiment, the exhaust opens into a recirculating conduit which returns exhausted air to a location upstream of the device, for example, to an inlet on the system air source, to improve efficiency and reduce dust.

In a further embodiment of the invention, a groove or coarse thread is provided on the hollow interior to help guide the material in a helical path towards the outlet. In one embodiment of the invention, a replaceable wear liner is also provided to extend the life of the separator. The liner which preferably is fabricated from an anti-corrosive and wear resistant material can be formed with a groove for material guidance or can be fabricated with a smooth interior.

These and other objects, features and advantages of the present invention will become apparent upon reading the detailed description below in view of the drawings.

### BRIEF DESCRIPTION OF THE DRAWINGS

FIG. 1 is a perspective view of an opener assembly with a decelerator attached to the delivery tube of an implement.

FIG. 2 is an enlarged perspective view of the decelerator of FIG. 1.

FIG. 3 is an alternate embodiment of the decelerator including a return line from exhaust connected to an air supply inlet or material container on the implement.

FIG. 4 is a perspective view of a decelerator with an integrally molded groove for guiding material towards the outlet.

FIG. 5 is a perspective view of a decelerator with a replaceable wear liner.

### DESCRIPTION OF THE PREFERRED EMBODIMENT

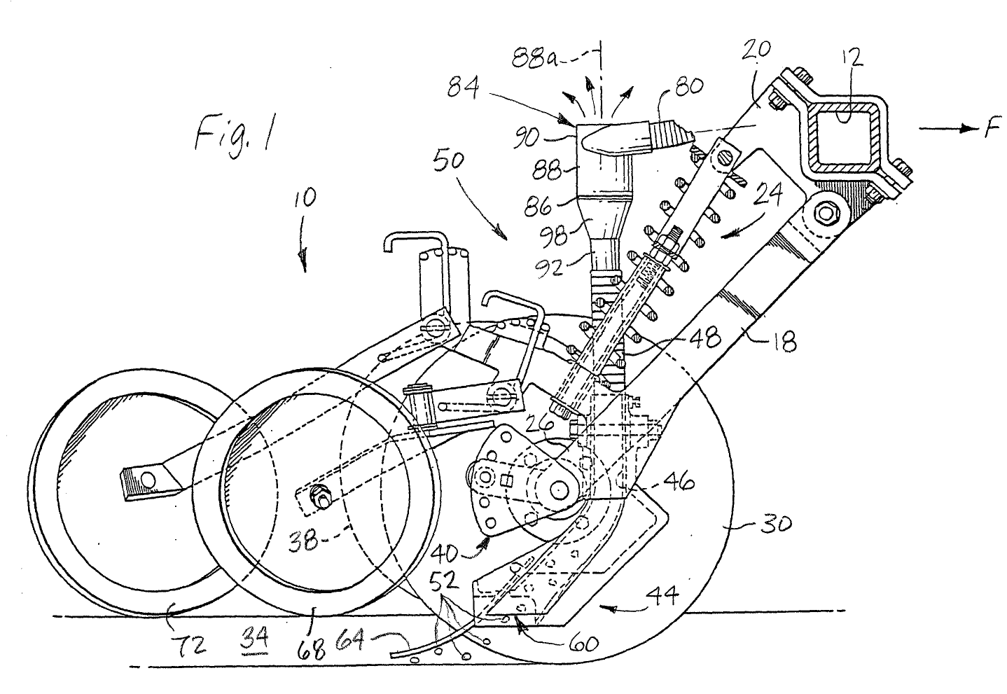

Referring now to FIG. 1, therein is shown a material placement device 10 connected to an implement frame tube 12 for forward movement (F) over the ground. The device 10, which is shown as a grain drill opener, includes a drawbar or arm 18 pivotally connected by bracket structure 20 to the tube 12 and biased downwardly into ground engagement by a spring assembly 24 connected between the bracket structure 20 and lower aft end 26 of the drawbar 18. An opener disk 30 is mounted at the end 26 for rotation about an axis offset from the forward direction for forming a narrow material-receiving furrow 34 in the ground. A depth gauging wheel 38 is mounted for rotation from a depth adjusting assembly 40 for rotation adjacent the leading face of the opener disk 30 to control furrow depth and to firm the soil on one side of the furrow 34.

A seed boot assembly 44 is supported from the aft end 26 adjacent the trailing side of the disk 30 in the shadow of the disk. The seed boot assembly 44 includes an upright seed tube 46 extending from a location above the arm 18 where the tube connects to the lower end of an upright conduit 48 which is part of an air distribution system 50. Seeds and/or fertilizer or other material, indicated generally at 52, metered from storage locations (not shown) on the implement is entrained in an air stream and propelled through the system for delivery to the assembly 44 and placement in the furrow 34. The material 52 passes downwardly through the conduit 48 and the seed tube 46 and then exits the seed tube at an outlet 60 which opens downwardly and rearwardly into the furrow 34. A seed bounce flap 64 extends downwardly and rearwardly from the aft end of the outlet 60. A press wheel assembly 68 supported from the arm 18 behind the disk helps to firmly position the seed in the lower portion of the furrow and increase seed-to-soil contact. A closing wheel 72 collapses soil from the opposite furrow wall and firms the soil against the material.

The air distribution system 50 includes a material supply conduit 80 wherein seed or seed and fertilizer or other similar material is conveyed by a volume of air from the storage location. A material decelerating device 84, generally in the form of a cyclone separator, includes a hollow body 86 having a cylindrical portion 88 with a cylinder axis 88a (FIG. 2). The body 86 includes an upstream end 90 with an inlet 91 opening generally tangentially into the cylindrical portion 88 at the upstream end 90. A downstream end 92 with a material outlet 94 opens downwardly in the axial direction and includes a truncated cone-shaped portion 98 tapering radially inwardly from the cylindrical portion 88 to the outlet 94 (that is, in the downstream direction). The body includes an opening 104 near the top of the cylindrical portion 88 for releasing air upstream of the material outlet 94 to reduce the amount of air exiting the material outlet. The opening 104 includes a cylindrical extension 106 generally concentric with the portion 88 and opening downwardly at a central location 108 below the inlet so that the air escapes without loss of the desired material being transported.

The outermost end of inlet 91 is slotted at area 110 and has an inner diameter (D of FIG. 2) approximately equal to but slightly greater than the outer diameter of the supply conduit 80. The supply conduit 80 is inserted within the inlet 91 and a clamp 112 is tightened against the outer end area 110 to retain the conduit within the inlet 91. Placing the conduit 80 within the inlet 91 avoids a stepped area that could wear and be a source of damage to seeds. The lower end of the conduit 48 is secured to the upright seed tube 46 and the upper end is positioned over the outlet 94 and clamped to the downstream end 92 of the decelerating device 84.

The inlet has an axis 91a which is angled in the downward direction several degrees from an imaginary plane which extends perpendicularly to the axis 88a to impart a slight axial component to the material entering the device 84 so the material will be directed towards the outlet 94. Preferably, the angle of the axis 91a to the plane is approximately five degrees. Seeds and other material entering the device 84 will tend to follow a helical path along the inner circumference of the cylindrical portion 88. As the material moves towards the outlet 94, the friction caused by centrifugal force gently slows the material without damage to the material. The material follows a helical path along the portion 98 and exits the downstream end 92. A substantial portion of the propelling air stream exits the device at the opening 104 via the extension 106. Preferably, the effective cross section of the opening 106 is greater than the area of the outlet 94 so the air can efficiently exhaust. With the device 84 constructed generally to the scale shown in the drawing figures, approximately ninety percent of the air is exhausted via opening 104.

The seeds and/or other material 52 drop under the influence of gravity through the conduit 48 and through the seed tube 46. By eliminating most of the air from the material path and slowing the material directly above the seed tube, the velocity of the material is reduced substantially and material acceleration downstream of the decelerating device 84 caused by air flow is generally eliminated. Therefore, blowing and bouncing of material from the furrow 34 and bouncing of the material in the furrow are substantially eliminated. The device 84 is compact and easily attached directly above the opener between the conduits 48 and 80 behind and generally below the frame 12.

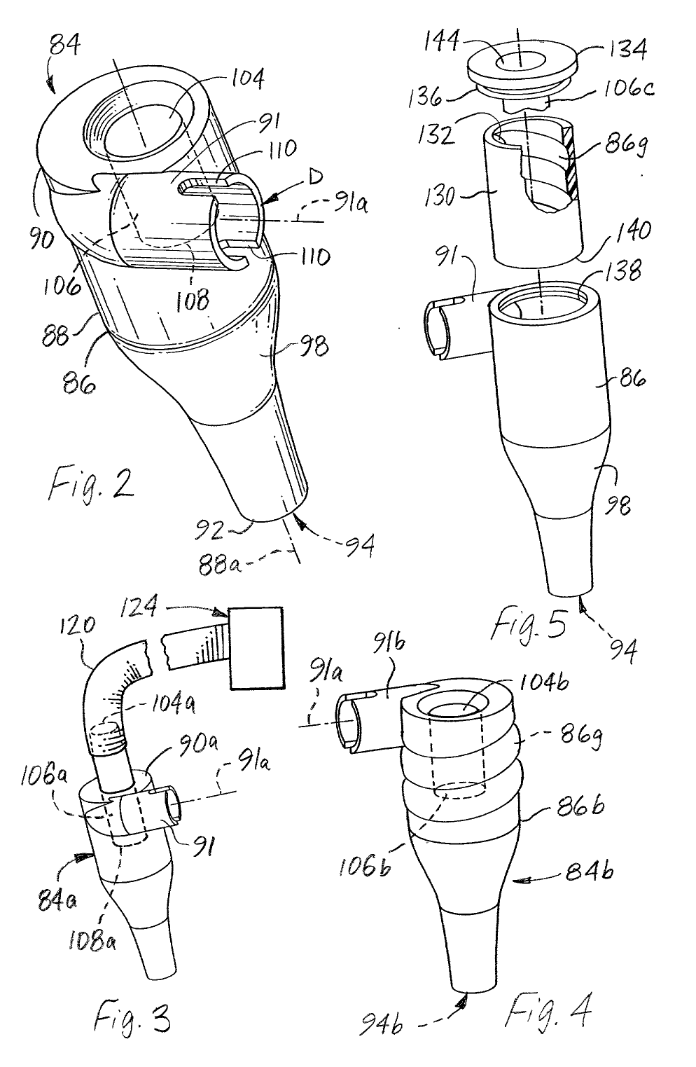

In an alternate embodiment (FIG. 3), a material decelerating device 84a includes an extension 106a which projects from the upstream end 90a and receives a return line 120 connecting an exhaust opening 104a with a remote location 124. Preferably, the location 124 is part of the distribution system upstream of the inlet 91. The location 124 can, for example, be the inlet of an air supply fan 124 or a material supply container or hopper at the storage location on the implement. The return line 120 can therefore be advantageously used for recirculation to increase air system efficiency, as well as to provide a generally closed system to reduce problems of dust and loss of fine material into the atmosphere without need for filters or the like. In a further modification, the location 124 can be an outlet opening closely adjacent or slightly penetrating the ground to direct dust and other fine materials on or into the ground. Preferably, the ground location is offset from the area of the furrow where the seed is being deposited at the time to avoid accelerating the seed or blowing seed or dirt from the furrow.

In the embodiment shown in FIG. 4, a material decelerating device 84b includes an inlet 91b opening having a hollow body 86b having a groove 86g for guiding the material towards the outlet 94b. The axis 91a of the inlet 91b is angled slightly towards the outlet 94b to impart motion in the direction of the groove 86g which is shown as generally helical. Air is exhausted via the extension 106b through the outlet 104b.

In the embodiment shown in FIG. 5, a replaceable wear liner 130 with an inlet accommodation opening 132 is slidably received within the hollow body 86 and is indexed with respect to the body in a conventional manner such as with a mating tab and groove so the opening 132 aligns with the inlet 91. A cap 134 with an air exhaust extension 106c (partially broken away in FIG. 5 to better show the interior of the liner 130) includes a snap ring 136 which mates with a molded groove 138 in the top of the body 86 to secure the liner within the body with a bottom edge 140 of the liner terminating at the cone-shaped portion 98. Air is exhausted through the extension 106c which opens through the cap 134 at 144. Grooves 86g may also be provided in the liner 130 to help guide material towards the outlet 94. In the embodiment shown, the grooves 86g help to guide the material in a helical path towards the outlet. Alternatively, the liner 130 can be non-grooved.

The body 86 can be fabricated using any of a number of conventional methods including injection molding of plastic. The insert 130 can be fabricated from a wear-resistant plastic material or a corrosion-resistant metal such as stainless steel. Preferably, the insert 130 is fabricated from ultra high molecular weight polyethylene (UHMW-PE) or urethane.

Having described the preferred embodiment, it will become apparent that various modifications can be made without departing from the scope of the invention as defined in the accompanying claims.

We claim:

1. A material decelerator for the reducing material speed and air velocity in an air distribution system upstream of a distribution system outlet which places the material conveyed by air in a furrow in the ground, the material decelerator comprising:
a hollow body having a cylindrical portion with an upstream end and a downstream end and a cylinder axis;
a material inlet opening generally tangentially into the upstream end of the cylindrical portion;
a material outlet opening generally in the axial direction from the downstream end of the cylindrical portion and tapering radially inwardly in a downstream direction; and
the hollow body including an opening for releasing air from the hollow body upstream of the material outlet to thereby reduce the amount of air exiting the material outlet.

2. The decelerator as set forth in claim 1 wherein the inlet defines an inlet axis angled slightly towards the downstream end so that material entering the hollow body is directed towards the downstream end.

3. The decelerator as set forth in claim 1 wherein the opening has an effective area greater than that of the material outlet so there is less resistance to air flow at the opening than at the material outlet.

4. The decelerator as set forth in claim 1 wherein the cylinder axis is upright and the material inlet is angled downwardly towards the material outlet on the order of five degrees relative to a plane extending perpendicularly to the cylinder axis.

5. The decelerator as set forth in claim 1 wherein the cylinder axis is upright and the material outlet opens downwardly towards the distribution system outlet so that the material falls under the influence of gravity from the material outlet.

6. The decelerator as set forth in claim 1 wherein the material inlet includes a projection extending generally tangentially from the cylindrical portion and has a distributor conduit receiving bore adapted for connecting to an upstream tube member of the distribution system, the projection adapted for receiving the tube member within the bore to avoid a stepped area that could be impinged by the material.

7. The decelerator as set forth in claim 3 wherein the material outlet has an area approximately equal to that of the material inlet.

8. The decelerator as set forth in claim 1 including a groove located within the hollow body and guiding material towards the material outlet.

9. The decelerator as set forth in claim 1 wherein the hollow body is located directly above the furrow and the downstream end opens downwardly towards the furrow, and wherein the material inlet has a substantial horizontal component and forms an angle of between 3 and 5 degrees with a plane extending perpendicularly to the cylinder axis.

10. The decelerator as set forth in claim 1 including a conduit connected to the opening and delivering exhausted air to a location on the air distribution system upstream of the material inlet.

11. The decelerator as set forth in claim 1 including a replaceable wear liner supported within the hollow body, the material impacting the wear liner.

12. A material decelerator for the reducing material speed and air velocity in an air distribution system upstream of a distribution system outlet which places the material conveyed by air in a furrow in the ground formed by an opener which trails an implement frame, the material decelerator comprising:
a hollow body with a generally round portion and including an upstream end and a downstream end;
a material inlet opening generally tangentially into the round portion adjacent the upstream end;
a material outlet opening from the downstream end; and
an opening for releasing air from the hollow body upstream of the material outlet to thereby reduce the amount of air exiting the material outlet, and wherein the material inlet and the hollow body provide a material path around the hollow body and offset from the opening so that the material is gently slowed by centrifugal force before exiting the outlet, a substantial portion of the air exhausting from the opening.

13. The decelerator as set forth in claim 12 wherein the material outlet opens downwardly directly above the distribution system outlet so that the material moves downwardly under the influence of gravity without substantial acceleration by air which is not exhausted from the opening.

14. The decelerator as set forth in claim 13 wherein the material inlet angles downwardly towards the material outlet.

15. The decelerator as set forth in claim 12 wherein the hollow body is supported above the opener rearwardly of the frame close to the material system outlet.

16. The decelerator as set forth in claim 15 wherein the hollow body is supported between the frame and the distribution system outlet with the material outlet adjacent the opener.

17. The decelerator as set forth in claim 12 including a conduit connected to the exhaust and directing exhausted air away from the distribution outlet.

18. The decelerator as set forth in claim 17 wherein the conduit is connected to an air supply inlet of the distribution system.

19. The decelerator as set forth in claim 17 wherein the conduit is connected to a material container.

20. A method of decelerating material in an air distribution system on an agricultural implement having an opener device and a material placement device for placing material in a furrow formed by the opener, the method comprising:
inserting a cyclone separator in the air distribution system upstream of the material placement device;
slowing the material in the cyclone separator; and
exhausting a substantial portion of air in the air distribution system from the cyclone separator.

21. The method as set forth in claim 20 wherein the step of inserting a cyclone separator includes locating the separator closely adjacent the material placement device.

22. The method as set forth in claim 21 wherein the step of exhausting a substantial portion of the air includes exhausting approximately ninety percent of the air.

23. The method as set forth in claim 20 further including the step of directing the exhausted air to a location in the air distribution system upstream of the cyclone separator.

24. Wear insert structure for a cyclone separator having a hollow body with a cylindrical portion of preselected inner diameter, an inlet located at an upstream end of the body, and an outlet located at a downstream end of the body, the wear insert structure comprising:
a replaceable insert having a hollow cylindrical member with an inner wear surface and an outer diameter approximately equal to but slightly less than the preselected inner diameter, the insert adapted for receipt within the hollow body and including an inlet accommodating area alignable with the inlet for receiving air-delivered seeds and other planting material from the inlet and directing the material around the inner wear surface towards the outlet; and
securing structure for maintaining the cylindrical member within the hollow body and selectively releasing the member from the body for repair or replacement.

25. The wear insert structure as set forth in claim 24 wherein the inner wear surface includes a groove for guiding the material around the inner wear surface.

26. The wear insert structure as set forth in claim 24 wherein the inner wear surface includes a generally helical groove for gently guiding seeds around the inner wear surface towards the outlet.

27. The wear insert structure as set forth in claim 24 wherein the securing structure comprises a cap member having an air opening for exhausting air from the separator.

28. The wear insert structure as set forth in claim 27 wherein the air opening includes an extension projecting axially into the hollow body for exhausting air from a central portion of the separator.

29. The wear insert structure as set forth in claim 24 wherein the replaceable insert is fabricated from ultra high molecular weight polyethylene.

30. The wear insert structure as set forth in claim 24 wherein the replaceable insert is fabricated from stainless steel.
